(19) United States
(12) Patent Application Publication
(10) Pub. No.: US 2007/0224326 A1
(43) Pub. Date: Sep. 27, 2007

(54) Flour products having multi-flavor, multi-variety, and rich nutrition

(76) Inventor: Ke-Yi Li, Shanghai (CN)

Correspondence Address: Raymond Y. Chan, Suite 128, 108 N. Ynez Avenue, Monterey Park, CA, 91754, US

(21) Appl. No.: 11/717,940

(22) Filed: Mar. 13, 2007

Related U.S. Application Data
(63) Continuation-in-part of application No. 10/630,003, filed on Jul. 29, 2003, now abandoned.

(30) Foreign Application Priority Data
Aug. 6, 2002 (CN) 022664040.2

(51) Int. Cl. A21D 10/00

(52) U.S. Cl. 426/558; 426/549

(57) ABSTRACT

A flour product includes a predetermined of flour powder, a predetermined of nutritional food product mixing with the flour to form a predetermined amount of a pre-mixed flour element, a predetermined amount of water mixing with the pre-mixed flour element to form a flour dough, and a predetermined amount of at least one additional ingredient thoroughly mixing with the flour dough, wherein the additional ingredient optimally enhances a nutrition value of the flour product which have a multi-favor taste corresponding with the flour, the nutritional food product.

### CROSS REFERENCE OF RELATED APPLICATION

This is a Continuation-In-Part of a non-provisional application having an application Ser. No. 10/630,003 and a filing date of Jul. 29, 2003.

### BACKGROUND OF THE PRESENT INVENTION

1. Field of Invention

The present invention relates to flour products having multi-flavor, multi-variety, and rich nutrition, and more particularly to the flour products that are able to renovate and replace the conventional ones.

2. Description of Related Arts

Regarding the convention flour products, varieties are rarely renovated, flavors remains unchanged, and nutrition is far from complete and prefect. In view of the current flour products such as steamed bun, meat stuffed bun, mooncake, cake, sweet dumpling, dessert, instant noodle, noodle, and all Chinese light meal, it is found that although there are a lot of varieties, the flavors have not changed much. Most of them only have natural, salty, and/or sweet taste as before. Although sometimes there are some differences in terms of taste and nutrition, it depends on the changing of filings for example shrimps, meat of birds, or pork. It is becoming harder and harder for the taste of such flour products to meet the growing requirement of people for delicious food.

### SUMMARY OF THE PRESENT INVENTION

The main object of the invention is to renovate a taste of traditional Chinese flour products which only have natural, salty, and/or sweet taste. A serial flour products having multi-flavor, multi-variety, and rich nutrition, is produced by adding a certain amount of juice, granules, fine granule, or powder of one or more flavor materials such as vegetables, fruits, sea foods, domestic birds, wild birds, plants, fungus, or condiments into dry, wet or yeasted flour, and adding a certain amount of water and then producing a series of semi- or finished bean products. The oriental flour product can have composite material; the flavor thereof can be composite flavor; the nutrition can be composite nutrition; for a single new product, the flavor can be single-flavor and single-nutrition, or multi-flavor and multi-nutrition, or even composite flavor and composite nutrition, for the flour products, the flavor can be single-flavor and signal nutrition, or multi-flavor and multi-nutrition, or even composite flavor and composite nutrition.

Another object of the invention is to provide a combination of the flour products and filing, such as meat granules, contained therein, which is single-flavor and single-nutrition, or multi-flavor and multi-nutrition, or even composite flavor and composite nutrition.

Another object of the invention is to provide a flour product having multi-flavor, multi-variety, and rich nutrition, which is produced by adding a certain amount of juice, granules, fine granules, or powder of more than one flavor materials, and then adding a certain amount of water.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of one embodiment of the invention showing a process of the invention.

FIG. 2 is first alternative mode of a method of producing a flour product according to the above preferred embodiment of the invention.

FIG. 3 is a second alternative mode of a method of producing a flour product according to the above preferred embodiment of the invention.

### DETAILED DESCRIPTION OF THE PREFERRED EMBODIMENT

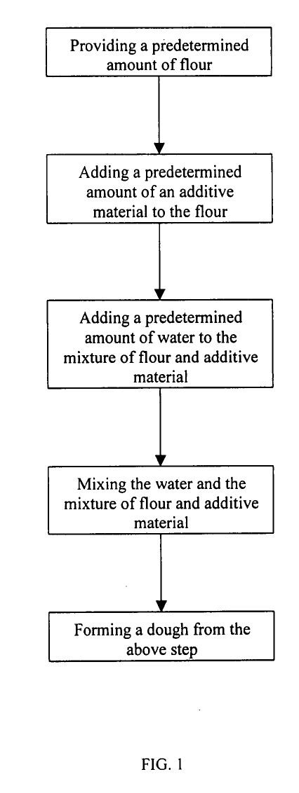

Referring to FIG. 1 of the drawings, the present invention is a nutritious flour product and the process of producing the like. A predetermined amount of flour material is provided and a predetermined amount of comminuted additive material is added. A predetermined amount of water is then added. The flour material and the comminuted additive material are thoroughly mixed together forming the nutritious flour product. The nutritious flour product can then be used to produce a final finished product, such as wrapping fillings therewithin.

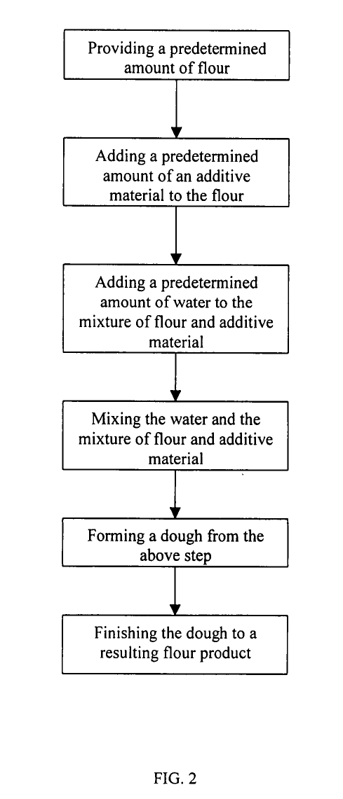

Referring to FIG. 2 of the drawings, the present invention is a first alternative mode of the nutritious flour product and the corresponding process of producing the like. A predetermined amount of flour material is provided and then a predetermined amount of more than one types of comminuted additive material is added. A predetermined amount of water is then added. The flour material and the comminuted additive materials are thoroughly mixed together forming the nutritious flour product. The nutritious flour product can then be used to produce a final finished product, such as wrapping fillings therewithin.

The present invention is a novel food product. Not only is it able to improve the appearance, smell, and flavor of flour related products, it can also provide better nutrients and increase the quality and standard of such products. It can create a new generation of serial foods being convenient, useful, and various.

In comparison with conventional flour related products, the flavor and nutrition of the present invention is highly improved through acquiring the flavor and nutrition from the additive material while keeping the original natural, salty or sweet taste of conventional flour products. By combining different additive materials together, different nutritious flour products can be created.

By combining two or more types of comminuted additive materials together, the present invention is capable of having composite flavors and composite nutrition.

The use of different combinations of comminuted additive materials can create single-flavor and single-nutrition, multi-flavor and multi-nutrition, or composite flavor and composite nutrition nutritious flour products.

The flavor of the present invention, when combined with different filings such as shrimps, poultries, or pork, can be single-flavor and single-nutrition, or multi-flavor and multi-nutrition, or even composite flavor and composite nutrition.

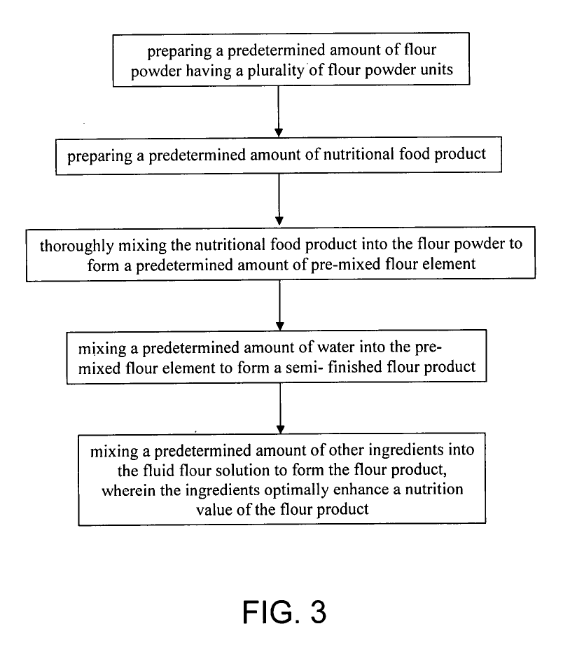

Referring to FIG. 3 of the drawings, a second alternative mode of the method of manufacturing the flour products according to the preferred embodiment of the present invention is illustrated. The second alternative mode is similar to the preferred embodiment except there exist additional steps in pre-mixing the flour materials. According to the second alternative mode, the method of producing a flour product, comprising the steps of:

(a) preparing a predetermined amount of flour powder having a plurality of flour powder units;

(b) preparing a predetermined amount of nutritional food product;

(c) thoroughly mixing the nutritional food product into the flour powder to form a predetermined amount of pre-mixed flour element;

(d) mixing a predetermined amount of water into the pre-mixed flour element enough to form a semi-finished flour product as a flour dough; and

(e) mixing a predetermined amount of other ingredients into the flour dough to form the flour product, wherein the ingredients optimally enhance a nutrition value of the flour product.

According to the preferred embodiment of the present invention, step (b) comprises the steps of:

(b.1) putting the a predetermined of designated food into a predetermined amount of water;

(b.2) boiling the water with the food for extracting the nutrition of the food product into the water, wherein the boiled water and designated food becomes a nutritional solution containing a predetermined amount of nutritional food crystals;

(b.3) fully evaporating the nutritional solution to leave the nutritional food crystals as residuals of the nutritional solution; and

(b.4) grinding the nutritional crystals into powdered form having a plurality of powder units for mixing with the flour powder, wherein the size of each of the powder unit of the powdered nutritional crystals is not larger than the size of each of the flour powder units of the flour powder to form the nutritional food product.

In step (b.2), the boiling of the water and the food can be accomplished within a sealed chamber so as to resemble the effect of waterbath cooking method as prevalent among traditional Chinese cooking methods.

Step (c) comprises a step of adding the nutritional food product into the flour powder for thoroughly mixing the nutritional food product with the flour powder to form the pre-mixed flour element.

The other ingredients mentioned in step (e) comprise baker powder, soda powder or soda water, and/or well-stirred egg. According to the circumstances in which the flour product is to be consumed or further processed, the user may selectively and optimally determine the proper amount of each or some of the ingredients which are to be added into the water-added pre-mixed flour element.

The method further comprises a step of fermenting the mixture of the flour, the nutritional food product, the water, and the additional ingredient with at least one predetermined fermentation agent to form the flour product having multi-favor and high nutritional value. Thus, the fermented flour product resembles much of a bread product which is then widely consumed as a regular food. The fermentation agent is preferably a predetermined amount of cheese or a predetermined amount of alcoholic product.

Finally, it is important to point out that the nutritional food product which is added to the flour comprises extracts or tiny fragments of high-nutritional plants which are to be mixed into the flour for rendering the flour product to be highly nutritious and tasty. For example, the nutritional food product may be of oriental origin so that the taste of the flour resembles much of a traditional favor. According to the preferred embodiment of the present invention, the nutritional food product is vegetables which are to be grinded to mix with the flour. The vegetables can be of oriental origin such as traditional Chinese vegetables. Alternatively, the nutritional food product can be herbs which are supplements to daily diets. The herbs can be traditional Chinese herbs such as aloe extracts. It is worth mentioning that the volume ratio of the nutritional food product to the flour powder is at most one to ten.

Another alternative of the nutritional food product is that it can be made from meat as the designated food. For example, the designated food can be a predetermined amount of chicken or pork which are immersed into the water and boiled to form the nutritional solution.

Finally, as a particular embodiment of the present invention, the flour product of the present invention is embodied as comprising the flour powder, two or more flavor materials mixing with the flour, and water mixing with a mixture of the flour powder and the flavor material to form a semi-finished flour product, wherein the flavor material is selected from the group consisting of juice, granules, powder of at least one of vegetables, fruits, seafood, domestic birds, wild birds, plants and fungus, wherein the semi-finished flour product is cooked to form a finished flour product selected from a group consisting of steamed bun, meat stuffed bun, moon cake, cake, sweat dumpling, instant noodle, and noodle, such that the finished flour product contains multi-flavor and rich nutrition.

It is worth mentioning that once the flour product is formed, a user of the present invention is able to stuff additional ingredients, such as meat slices, or vegetables etc. into the flour product which is then cooked or baked to form an oriental food product.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of manufacturing flour products, comprising said steps of:
(a) preparing a predetermined amount of flour powder;
(b) preparing a predetermined amount of nutritional food product;
(c) thoroughly mixing said nutritional food product into said flour powder to form a predetermined amount of pre-mixed flour element;
(d) mixing a predetermined amount of water into said pre-mixed flour element enough to form a semi-finished flour product as a flour dough; and
(e) mixing a predetermined amount of other ingredients into said flour dough to form said flour product, wherein said ingredients optimally enhance a nutrition value of said flour product.

2. The method, as recited in claim 1, wherein step (b) comprises said steps of:
(b.1) putting a predetermined of designated food into a predetermined amount of water;
(b.2) boiling said water with said designated food for extracting nutrition of said designated food into said water, wherein said boiled water and nutritional food product becomes a nutritional solution containing a predetermined amount of nutritional food crystals;
(b.3) fully evaporating said nutritional solution to leave said nutritional food crystals as residuals of said nutritional solution; and
(b.4) grinding said nutritional crystals into powdered form having a plurality of powder units for mixing with said flour powder, wherein a size of each of said powder units of said powdered nutritional crystals is not larger than a size of each of said flour powder units of said flour powder to form said nutritional food product.

3. The method, as recited in claim 1, wherein said additional ingredient mentioned in said step (e) is selected from the group consisting of baker powder, soda powder, soda water, and well-stirred egg.

4. The method, as recited in claim 2, wherein said additional ingredient mentioned in said step (e) is selected from the group consisting of baker powder, soda powder, soda water, and well-stirred egg.

5. The method, as recited in claim 3, wherein said step (c) comprises a step of adding said nutritional food product into said flour powder for thoroughly mixing said nutritional food product with said flour powder to form the pre-mixed flour element.

6. The method, as recited in claim 4, wherein said step (c) comprises a step of adding said nutritional food product into said flour powder for thoroughly mixing said nutritional food product with said flour powder to form the pre-mixed flour element.

8. The method, as recited in claim 5, wherein said nutritional food product comprises extracts of high-nutritional plants which are to be mixed into said flour powder for rendering said flour product to be highly nutritious and tasty.

9. The method, as recited in claim 6, wherein said nutritional food product comprises extracts of high-nutritional plants which are to be mixed into said flour powder for rendering said flour product to be highly nutritious and tasty.

10. The method, as recited in claim 5, wherein said nutritional food product is herbs which are supplements to daily diets.

11. The method, as recited in claim 6, wherein said nutritional food product is herbs which are supplements to daily diets.

12. The method, as recited in claim 5, wherein said nutritional food product comprises a predetermined amount of meat.

13. The method, as recited in claim 6, wherein said nutritional food product comprises a predetermined of meat.

14. The method, as recited in claim 1, further comprising a step of fermenting said mixture of said flour powder, said nutritional food product, said water, and said additional ingredient with at least one predetermined fermentation agent to form said flour product having multi-favor and high nutritional value.

15. The method, as recited in claim 13, further comprising a step of fermenting said mixture of said flour powder, said nutritional food product, said water, and said additional ingredient with at least one predetermined fermentation agent to form said flour product having multi-favor and high nutritional value.

16. The method, as recited in claim 15, wherein in said step (b.2), said water and said designated food are boiled within a sealed chamber to resemble a water bath Chinese cooking method for said designated food.

17. A flour product, comprising a predetermined of flour powder, a predetermined of nutritional food product mixing with said flour powder to form a predetermined amount of a pre-mixed flour element, a predetermined amount of water mixing with said pre-mixed flour element to form a flour dough, and a predetermined amount of at least one additional ingredient thoroughly mixing with said flour dough, wherein said ingredients optimally enhance a nutrition value of the flour product which have a multi-favor taste corresponding with said flour, said nutritional food product, and said additional ingredients.

18. The flour product, as recited in claim 17, wherein said nutritional food product comprises extracts of high-nutritional plants which are to be mixed into said flour for rendering said flour product to be highly nutritious and tasty.

19. The flour product, as recited in claim 17, wherein said nutritional food product comprises a predetermined amount of meat.

20. The flour product, as recited in claim 17, wherein said additional ingredients are selected from the group consisting of baker powder, soda powder, soda water, and well-stirred egg.
